(19) United States
(12) Patent Application Publication
(10) Pub. No.: US 2026/0297922 A1
(43) Pub. Date: Oct. 1, 2026

(54) OPTICAL CONTROL SYSTEM FOR A WET WELL

(71) Applicant: Schneider Electric Systems USA. Inc., Foxborough, MA (US)

(72) Inventors: James Redmond, Richmond (CA); Zackery Sobin, Tryon, NC (US)

(21) Appl. No.: 19/095,749

(22) Filed: Mar. 31, 2025

(51) Int. Cl. E03F 5/10; G05B 23/02; G06T 7/00; G06T 7/55; G06T 7/60; G06T 7/70

(52) U.S. Cl. CPC E03F 5/107; G05B 23/0218; G05B 23/027; G06T 7/0002; G06T 7/55; G06T 7/60; G06T 7/70; G06T 2207/30204; G06T 2207/30232

(57) ABSTRACT

An optical control system for a wet well is configured to monitor and control operations of the wet well. The optical control system comprises one or more cameras configured to capture one or more images of an interior of the wet well. The cameras send the one or more images to a control processor associated with the wet well. The control processor evaluates the one or more images to detect changes in conditions of the wet well. Some conditions detected by the control processor include: waste water level in the well, the presence of a fat ring in the wet well, the presence of foreign object debris in the wet well, and whether all pumps are operating. Based on the evaluation, the control processor will execute a control routine to normalize conditions of the wet well. Furthermore, the control processor is configured to alert a user based on the evaluation.

### FIELD

The present disclosure generally relates to an optical control system for a wet well.

### BACKGROUND

A wet well is a large underground tank or chamber used to collect wastewater from a building or group of buildings. The wet well acts as a reservoir where wastewater accumulates until it reaches a certain level, at which point one or more pumps activate to move the wastewater to a treatment facility. Conventionally, wet wells are equipped with expensive instrumentation to monitor and control conditions of the wet wells. Furthermore, existing well control systems rely on specialized knowledge of programming standards, such as the International Electrotechnical Commission (IEC) 61131-3 or 61499, to set up and run the well control systems.

### SUMMARY

Aspects of the present disclosure provide systems and methods for optically monitoring conditions of a wet well.

In one aspect, an optical control system for a wet well comprises a camera configured to capture at least one image of an interior of the wet well. A control processor is coupled to the camera and configured to receive the image of the wet well. A memory stores processor-executable instructions that, when executed, configure the control processor for evaluating the image to detect a condition of the wet well.

In another aspect, an optical control system for a wet well comprises a first camera configured to capture a first image of an interior of the wet well from a first angle. A second camera is configured to capture a second image of the interior of the wet well from a second angle different from the first angle. A control processor is coupled to the first and second cameras and configured to receive the first and second images. A memory stores processor-executable instructions that, when executed, configure the control processor for evaluating the first and second images to detect a position of an object in the wet well.

In another aspect, a method of controlling a wet well comprises monitoring, with a camera and a control processor coupled to the camera, a condition of the wet well. The control processor detects a change in the condition of the wet well. The camera captures an image of the wet well. The control processor receives the image of the wet well. The control processor processes the image of the wet well to determine a control routine for the wet well.

Other objects and features will be in part apparent and in part pointed out hereinafter.

### BRIEF DESCRIPTION OF THE DRAWINGS

FIG. 1 is a schematic diagram illustrating wet wells being controlled by an optical control system according to embodiments of the present disclosure;

FIG. 2 is a schematic diagram illustrating a wet well from FIG. 1 having a window according to embodiments of the present disclosure;

FIG. 3 is a block diagram illustrating an exemplary optical control system according to embodiments of the present disclosure;

FIG. 4 is a schematic diagram illustrating a wet well from FIG. 1 having an additional camera according to embodiments of the present disclosure;

FIG. 5 is a schematic diagram illustrating the wet well from FIG. 2 having an additional window and an additional camera according to embodiments of the present disclosure;

FIG. 6 is a flow diagram illustrating an exemplary method that may be used by an optical control system according to embodiments of the present disclosure.

Corresponding reference characters indicate corresponding parts throughout the drawings.

### DETAILED DESCRIPTION

Wet wells are prone to several issues that can affect damages to well components and halt well operations. Therefore, it is crucial to monitor wet wells to mitigate such issues. Conventional wet well monitoring systems include expensive instrumentation that can be challenging to set up and install. The present disclosure is directed to systems and methods for monitoring and controlling a wet well using simple and cost-effective equipment. As will be described in greater detail below, the present disclosure includes an optical control system that utilizes one or more cameras and image processing techniques to monitor a condition of a wet well. Based on the monitored condition of the well, the optical control system is configured to determine and execute a control routine to normalize the condition of the wet well.

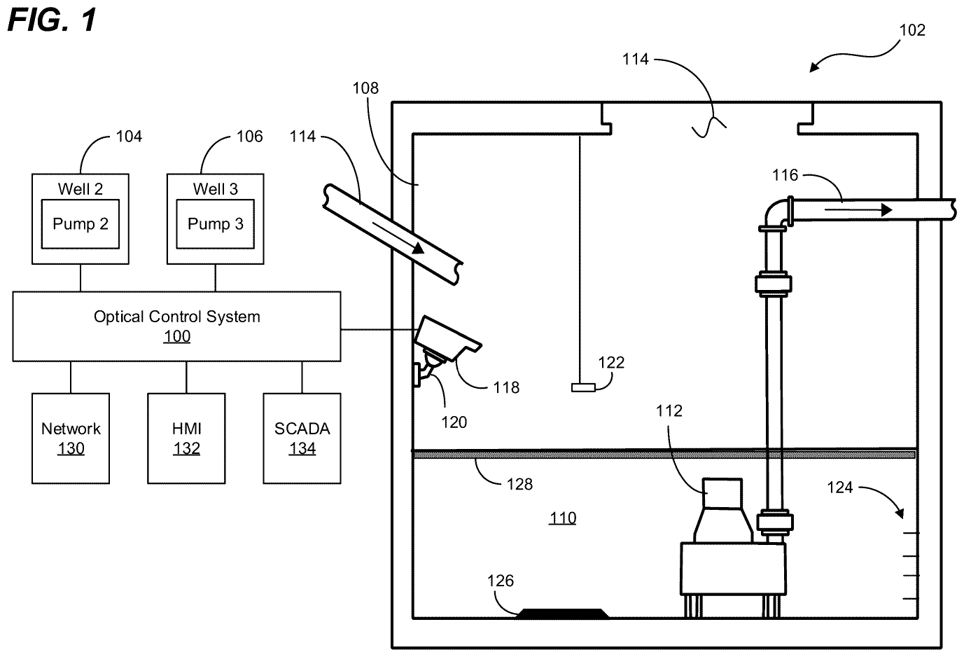

Referring now to FIG. 1 a schematic diagram is shown for an exemplary optical control system 100 that can monitor and control operations at a wet well 102 according to embodiments of the present disclosure. The optical control system 100 may be any wet well control system known to those having ordinary skill in the art that has sufficient processing capacity to perform the monitoring and control techniques disclosed herein. Examples include microcomputers, programmable logic controllers (PLC), remote terminal units (RTU), programmable automation controllers (PAC), and the like.

In addition to the wet well 102, a typical sewage system includes several additional wet wells that are also controlled by the optical control system 100, indicated here as wells 104, 106 (Well 2, Well 3). These wells may be connected to the optical control system 100 using a suitable communication link, such as Ethernet, Wi-Fi, Bluetooth, GPRS, CDMA, satellite, and the like. For economy of the present disclosure, only Well 1 is discussed in detail herein, with Well 2 and Well 3 having similar arrangements. And although three wells are shown in this example, it should be appreciated that the number of wells is exemplary, and the optical control system 100 may be used to monitor and control operations at fewer or more wells within the scope of the present disclosure.

As can be seen, the wet well 102 comprises a tank 108 with one or more inlets 114 through which wastewater 110 may enter the tank. In general, the wet well 102 is configured to temporarily store wastewater 110 until it reaches a certain volume to be pumped away by a submersible pump 112. The submersible pump 112 is configured to pump the wastewater 110 out of the tank 108 through an outlet 116 of the tank to move the wastewater to a treatment facility.

A camera 118 is installed at a strategic location to capture one or more images (including videos) of the interior of the wet well 102. The camera 118, may include one or more processors (not shown) which may be configured to provide a number of functions. For example, the camera processors may perform image processing, such as motion detection, on video streams captured by the camera 118. Other example methods such as computer vision and/or deep learning analytics are also contemplated as part of this disclosure. In embodiments, the camera 118 is configured to process a video stream captured by the camera on the camera to identify events occurring in the wet well 102 in the video stream, as will be described in further detail below. Some examples of suitable cameras include, infrared cameras and security cameras. However, a person of ordinary skill in the art will understand that other types of cameras may be used without departing from the scope of the present disclosure.

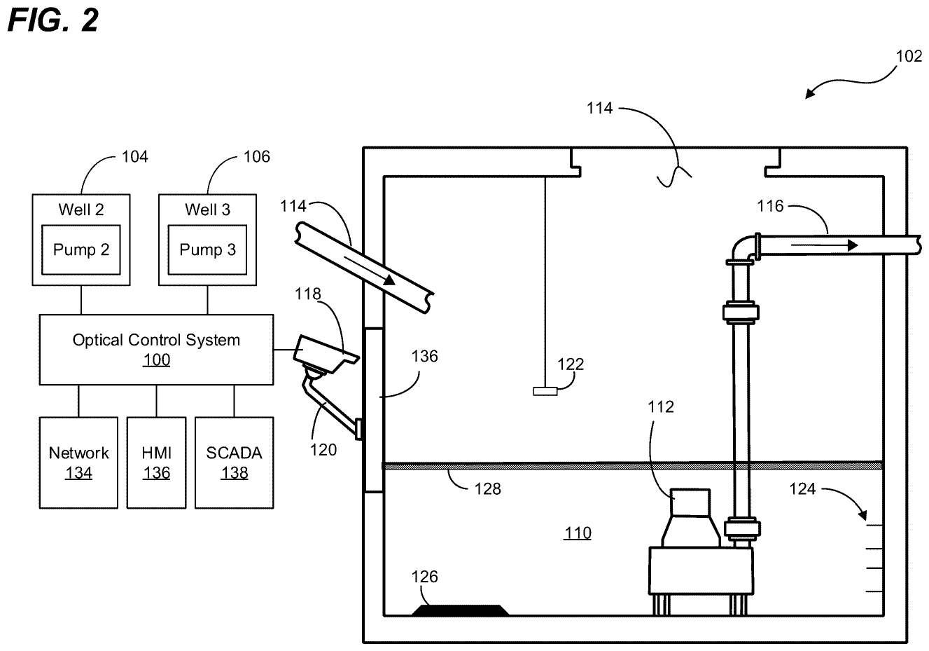

In FIG. 1, the camera 118 is mounted in the interior of the tank 108 using a mount 120. In FIG. 2, the camera 118 is mounted on the exterior of the tank 108 proximate a window 136 of the tank using mount 120. In the illustrated embodiments, the camera 118 is mounted to sidewalls of the tank 108; however, a person of ordinary skill in the art will understand that the camera may be mounted at any location as long as it is capable of capturing an image of the interior of the tank. The camera 118 and mount 120 are configured durably to withstand harsh environments associated with wet wells. It is envisioned, that the mount 120 and camera 118 may be configured to permit movement of the camera 118 to capture images of different angles of the interior of the tank 108, and alternatively, the mount and camera may be configured to be stationary within the tank.

In one embodiment, the camera 118 is configured to capture the one or more images of the wet well 102 at a scheduled interval. In other embodiment, the camera 118 is configured to continuously monitor the wet well 102, and based on the detection of an event, capture one or more images of the wet well. Broadly, the event is any phenomena that changes a condition of the wet well 102 and/or compromises operations of the well. Some examples of events detected by the camera 118 include, but are not limited to, the wastewater 110 in the tank 108 reaching a certain fluid height, a turbidity of the wastewater in the tank reaching a certain threshold, well component damage, foreign object debris 126 in the tank, the presence of a fat ring 128, and whether the pump(s) 112 are operating. It is contemplated that the camera 118 itself may be configured to detect such events, or the wet well 102 may also comprise auxiliary equipment such as, but not limited to, one or more additional sensors configured to detect such events and cue the camera to capture one or more images of the event. For example, the optical control system 100 further comprises a water level sensor 122 that is used to assess an event where the wastewater height in the tank 108 reaches a certain level. Once the sensor 122 detects the wastewater at a certain level, the sensor cues the camera 118 to capture one or more images of the tank 108. Other types of sensors associated with wet wells may be used to detect events without departing from the scope of the present disclosure. One or more reference markers 124 may also be disposed in the wet well 102 and captured in the image(s) by the camera 118.

The camera 118 is configured to transmit the acquired images over a wired or wireless connection to the optical control system 100. In another embodiment, the camera 118 is configured to transmit the acquired images over a wired or wireless connection to a non-transitory storage medium associated with the optical control system 100, and the optical control system is configured to retrieve the images from the non-transitory storage medium. The optical control system 100 typically receives or obtains the images at a sampling rate of one sample per second. Different sampling rates may of course be used as needed.

In accordance with embodiments of the present disclosure, the optical control system 100 monitors whether the wet well 102 (and other wells) is operating properly. The optical control system 100 performs this monitoring using the image(s) received from the camera 118. Specifically, the optical control system 100 evaluates the image(s) to detect a condition of the wet well 102. Some examples of conditions detected by the optical control system include, but are not limited to, the wastewater 110 in the tank 108 reaching a certain fluid height, a turbidity of the wastewater in the tank reaching a certain threshold, well component damage, foreign object debris 126 in the tank, and the presence of a fat ring 128. The optical control system 100 is configured to use known image processing techniques for determining such conditions. The optical control system 100, in one embodiment, is also configured to use the reference marker(s) 124 to detect a condition of the wet well 102. If any condition(s) other than the normal operating conditions of the wet well 102 are detected, the optical control system 100 is configured to generate an alert to a user to inform the user of the detected condition(s).

The optical control system 100 is further configured to determine and execute a control routine for the wet well 102 based on the detected condition of the wet well. Some examples of control routines include, but are not limited to, a pump prioritization operation, a foreign object debris de-ragging operation, a well maintenance operation, and a pump parameter adjustment operation. For example, the optical control system 100 may receive an image from the camera 118, and determine, by processing the image, that foreign object debris 126 is present in the tank 108. Accordingly, the optical control system 100 will then determine a control routine for eliminating the foreign object debris 126, such that normal operating conditions of the wet well 102 may be achieved. In this example, the optical control system 100 determines that a de-ragging operation is needed to remove the foreign object debris 126 from the tank 108, and therefore executes the de-ragging operation and/or notifies a user via an alert that a de-ragging operation must be performed.

In some embodiments, the optical control system 100 can also send the image(s) to a network 130 for storage and subsequent monitoring and tracking. Additionally, the optical control system 100 can transmit the image to an external control system, such as a supervisory control and data acquisition (SCADA) system 134. The transmissions may take place over any suitable communication link, such as Ethernet, Wi-Fi, Bluetooth, GPRS, CDMA, and the like. From there, the image may be forwarded to other systems within an enterprise and/or to a Cloud environment (which may include a private enterprise Cloud) for further processing as needed. Further, the optical control system 100 can display the image on a display, such as a human-machine-interface (HMI) 132, for review by a user. The user can then navigate the HMI 132 to manually control certain operations of the wet well 102 as needed via the optical control system 100.

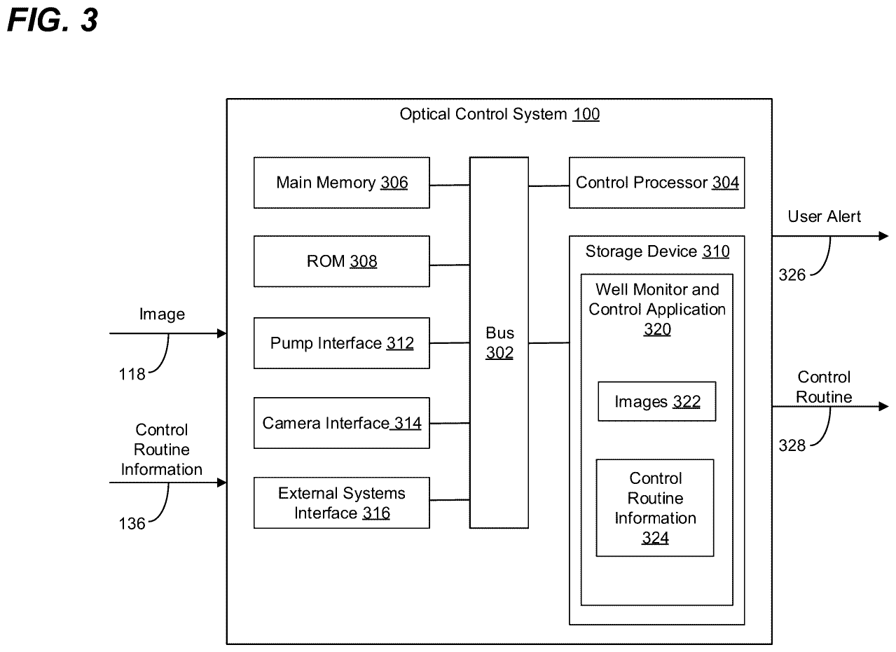

FIG. 3 is a block diagram illustrating an exemplary optical control system 100 in accordance with embodiments of the present disclosure. In one embodiment, the optical control system 100 includes a bus 302 or other communication pathway for transferring data within the optical control system, and a control processor 304, which may be any suitable microprocessor or microcontroller, coupled with the bus 302 for processing the information. In one embodiment, the control processor 304 is integrated within the camera 118. In another embodiment, the control processor 304 is remotely connected to the camera 118.

The optical control system 100 may also include a storage device such as a main memory 306 coupled to the bus 302 for storing processor-executable instructions to be executed by the control processor 304. For example, the main memory 306 stores processor-executable instructions that, when executed configure the control processor 304 for evaluating the image received or retrieved from the camera 118, to detect a condition of the wet well 102. Moreover, the processor-executable instructions configure the control processor 304 to generate a user alert based on the detected condition of the wet well 102, and at least one of determine and execute a control routine to normalize conditions of the wet well. The main memory 306 may also be used for storing temporary variables or other intermediate information (e.g., control routine information for addressing the determined condition(s) of the wet well 102) during execution of the instructions by the control processor 304.

The optical control system 100 may further include a read-only memory (ROM) 308 or other static storage device coupled to the bus 302 for storing static information and the processor-executable instructions for the control processor 304. A computer-readable storage device 310, such as a nonvolatile memory (e.g., Flash memory) drive or magnetic disk, may be coupled to the bus 302 for storing information and instructions for the control processor 304. The control processor 304 may also be coupled via the bus 302 to a well pump interface 312 for allowing the optical control system 100 to communicate with the submersible pump 112 and other well pumps at the wells connected thereto. A camera interface 314 may be coupled to the bus 302 for allowing the optical control system 100 to communicate with the camera 118 mounted at the wet well 102. An external systems interface 316 may be coupled to the bus 302 for allowing the optical control system 100 to communicate with various external systems, such as a touchscreen or HMI (e.g., HMI 136), SCADA system (e.g., SCADA system 138), network (e.g., network 134), and the like.

The term “processor-executable instructions” as used above refers to any instructions that may be performed by the control processor 304 and/or other components. Similarly, the term “computer-readable medium” refers to any storage medium that may be used to store the processor-executable instructions. Such a medium may take many forms, including, but not limited to, non-volatile media, volatile media, and transmission media. Non-volatile media may include, for example, optical or magnetic disks, such as the storage device 310. Volatile media may include dynamic memory, such as main memory 306. Transmission media may include coaxial cables, copper wire and fiber optics, including wires of the bus 302. Transmission itself may take the form of electromagnetic, acoustic, or light waves, such as those generated during radio frequency (RF) and infrared (IR) data communications. Common forms of computer-readable media may include, for example, magnetic medium, optical medium, memory chip, and any other medium from which a computer can read.

A well monitor and control application 320, or rather the processor-executable instructions, may also reside on or be downloaded to the storage device 310. The well monitor and control application 320 may then be executed by the control processor 304 (and other components) to automatically monitor and correct as well as prevent abnormal operations at the wet well 102 (and other wells) based on image(s) 322 from the camera 118 and pre-programmed control routine information 324. In one example, the pre-programmed control routine information 324 is user provided data via the HMI 136. The well monitor and control application 320 can then output a user alert 326 that notifies a user associated with the wet well 102 of the detected abnormal condition of the wet well. Furthermore, the well monitor and control application outputs a control routine 328 indicating a control routine to perform to normalize condition(s) of the wet well 102. In one example, the control routine 328 is included in the user alert 326. The control processor 304 is further configured to execute the generated control routine 328. Such a well monitoring and control application 320 may be written in any suitable computer programming language known to those skilled in the art, such as C, C++, C #, Python, Java, Perl, and the like.

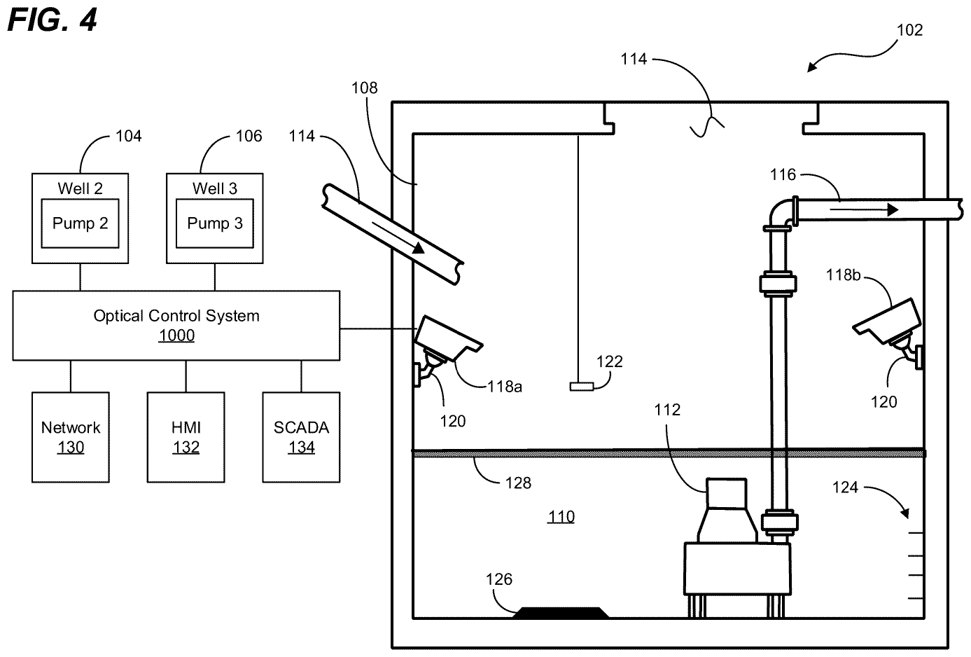

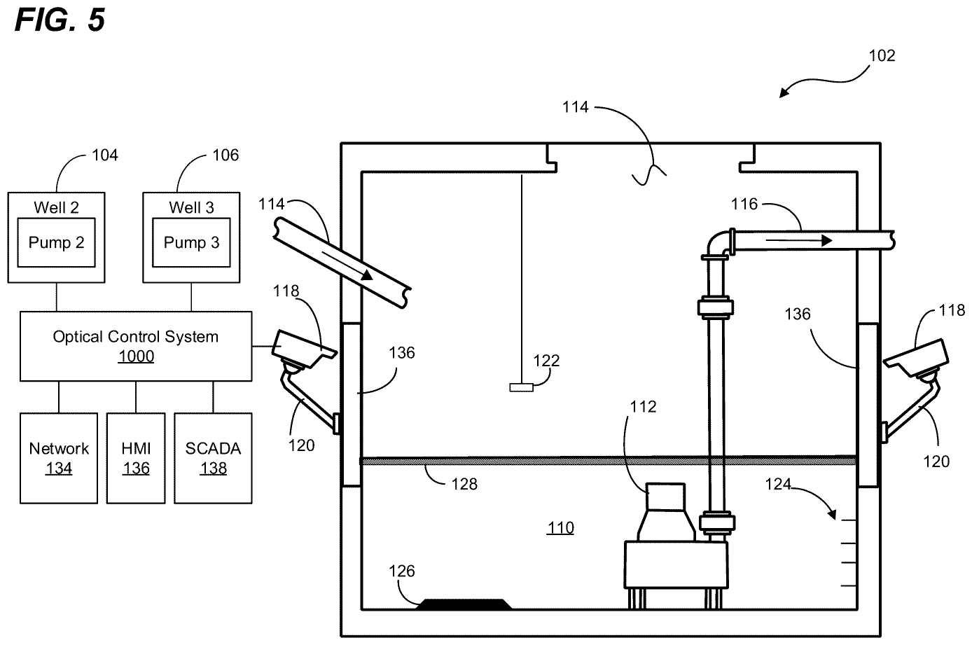

Referring now to FIGS. 4-5, another embodiment of an optical control system according to the present disclosure is generally indicated at reference number 1000. The optical control system 1000 is similar to the optical control system 100 of FIGS. 1-3, with the main difference being that the optical control system includes multiple cameras 118a, 118b for capturing different angles of the interior of the tank 108. Accordingly, the multiple cameras enable the optical control system 1000 to utilize stereo vision parallax to evaluate the images received from the cameras to detect a position of an object (e.g., foreign object debris 126, fat ring 128, and well components such as pump 112). This embodiment utilizes stereo vision parallax to: assess a depth to a top surface of water in the wet well, quantify size of debris, and measure distances of objects within the tank 108. For ease of description, where similar, analogous, or identical parts are used, identical reference numbers are employed. Accordingly, unless clearly stated or indicated otherwise, the descriptions regarding the optical control system 100 of FIGS. 1-3 also apply to the optical control system 1000 of FIGS. 4-5.

The optical control system 1000 utilizes multiple cameras to capture different angles of the interior of the tank. In FIGS. 4 and 5, a first camera 118a and a second camera 118b are mounted at different locations to capture images of the interior of the wet well 102 from different angles. In other words, the first camera 118a is installed to capture a first image of the interior of the wet well 102 from a first angle, and the second camera 118b is installed to capture a second image of the interior of the wet well from a second angle different from the first angle. Any number of cameras may be installed without departing from the scope of the present disclosure.

The memory 306 of the optical control system 1000 is further configured to store processor executable instructions that configure the control processor 304 for evaluating the first and second images from the first and second cameras 118a, 118b to detect a position of an object in the wet well 102. Specifically, the instructions configure the control processor 304 for evaluating the images captured at different angles to assess a depth to a top surface of water in the wet well, quantify size of debris, and measure distances of objects within the tank 108. These instructions may also be a part of the well monitor and control application 320.

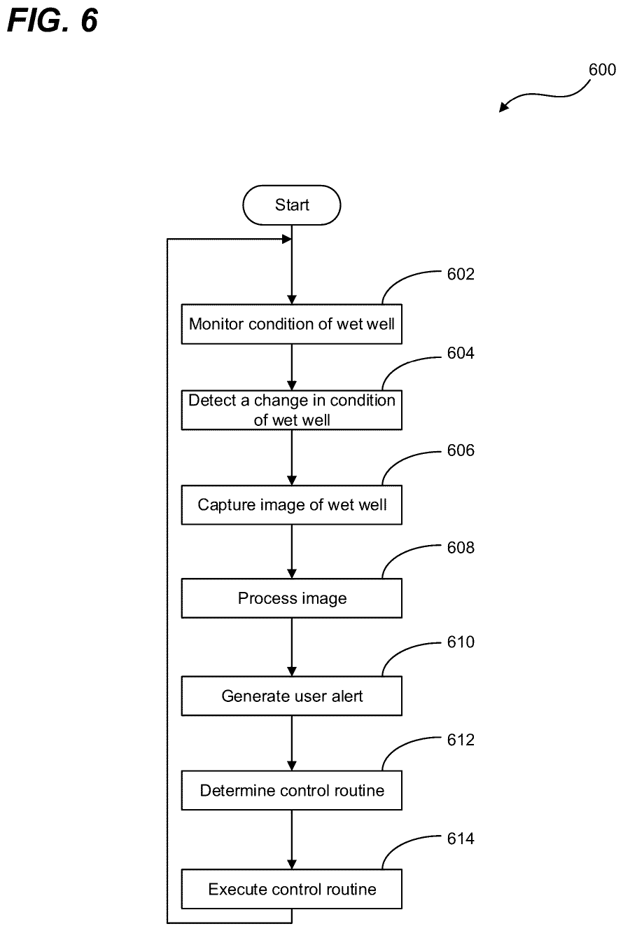

Thus far, specific embodiments of an optical control system have been described according to the present disclosure. Referring now to FIG. 6 a flowchart 600 is shown representing a general method that may be used with or by an optical control system according to embodiments of the present disclosure. The method may be used to monitor and control a wet well.

As can be seen in FIG. 6 the flowchart 600 generally begins at 602 where the wet well is monitored by a camera and optical control system coupled to the camera. Once a change in a normal condition of the wet well is detected (step 604), the camera captures an image of the wet well (step 606). At 608, the control processor receives or retrieves the image and processes the image to detect a condition of the wet well. At 610, the control processor generates a user alert to notify the user of the detected condition of the wet well. Based on the detected condition, the control processor determines a control routine to normalize the condition of the wet well at step 612 and executes the control routine at step 614. The flowchart 600 then returns to 602 to repeat the process on a continuous basis or as regularly scheduled.

Another aspect of the present disclosure includes a method for enabling optical control of a wet well. The method begins with an image capture device capturing one or more images of the wet well. Next an optical control system analyzes the images to determine one or more conditions affecting operation of the wet well. The conditions can comprise at least one of well level, the presence of a fat ring, the presence of floaters, debris, or other material inside the wet well, and whether all pumps are operating.

Having described the various embodiments in detail, it will be apparent that modifications and variations are possible without departing from the scope of the various embodiments defined in the appended claims.

Embodiments of the present disclosure comprise a special purpose computer including a variety of computer hardware, as described in greater detail herein and are operational with other special purpose computing system environments or configurations even if described in connection with an example computing system environment. The computing system environment is not intended to suggest any limitation as to the scope of use or functionality of any aspect of the various embodiments. Moreover, the computing system environment should not be interpreted as having any dependency or requirement relating to any one or combination of components illustrated in the example operating environment.

Examples of computing systems, environments, and/or configurations that may be suitable for use with aspects of the present disclosure include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Aspects of the present disclosure may be described in the general context of data and/or processor-executable instructions, such as program modules, stored one or more tangible, non-transitory storage media and executed by one or more processors or other devices. Generally, program modules include, but are not limited to, routines, programs, objects, components, and data structures that perform particular tasks or implement particular abstract data types. Aspects of the present disclosure may also be practiced in distributed computing environments where tasks are performed by remote processing devices that are linked through a communications network. In a distributed computing environment, program modules may be located in both local and remote storage media including memory storage devices. For purposes of illustration, programs and other executable program components may be shown as discrete blocks. It is recognized, however, that such programs and components reside at various times in different storage components of a computing device, and are executed by a data processor(s) of the device.

In operation, processors, computers, and/or servers may execute the processor-executable instructions (e.g., software, firmware, and/or hardware) such as those illustrated herein to implement aspects of one or more embodiments herein. The processor-executable instructions may be organized into one or more processor-executable components or modules on a tangible processor readable storage medium. Also, embodiments may be implemented with any number and organization of such components or modules. For example, aspects of the present disclosure are not limited to the specific processor-executable instructions or the specific components or modules illustrated in the figures and described herein. Other embodiments may include different processor-executable instructions or components having more or less functionality than illustrated and described herein.

The order of execution or performance of the operations in accordance with aspects of the present disclosure illustrated and described herein is not essential, unless otherwise specified. That is, the operations may be performed in any order, unless otherwise specified, and embodiments may include additional or fewer operations than those disclosed herein. For example, it is contemplated that executing or performing a particular operation before, contemporaneously with, or after another operation is within the scope of the present disclosure.

Not all of the depicted components illustrated or described may be required. In addition, some implementations and embodiments may include additional components. Variations in the arrangement and type of the components may be made without departing from the spirit or scope of the claims as set forth herein. Additional, different or fewer components may be provided and components may be combined. Alternatively, or in addition, a component may be implemented by several components.

When introducing elements of various embodiments herein, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that one or more embodiments herein can overcome at least some challenges that arise with at least some existing well control systems while providing advantageous improvements and results as discussed herein.

As various changes could be made in the above products without departing from the scope of the disclosed embodiments and examples, it is intended that all matter contained in the above description and shown in the accompanying drawings shall be interpreted as illustrative and not in a limiting sense.

The Abstract and Summary are provided to help the reader quickly ascertain the nature of the technical disclosure. They are submitted with the understanding that they will not be used to interpret or limit the scope or meaning of the claims. The Summary is provided to introduce a selection of concepts in simplified form that are further described in the Detailed Description. The Summary is not intended to identify key features or essential features of the claimed subject matter, nor is it intended to be used as an aid in determining the claimed subject matter.

1. An optical control system for a wet well, the optical control system comprising:
a camera configured to capture at least one image of an interior of the wet well;
a control processor coupled to the camera and configured to receive the image of the wet well; and
a memory storing processor-executable instructions that, when executed, configure the control processor for evaluating the image to detect a condition of the wet well.

2. The optical control system of claim 1, wherein the memory stores processor-executable instructions that, when executed, further configure the control processor for executing a control routine associated with the wet well based on the detected condition of the wet well.

3. The optical control system of claim 2, wherein said condition comprises at least one of wastewater in the wet well reaching a certain fluid height, a turbidity of the wastewater at a certain threshold, wet well component damage, a fat ring, wet well component operation, or foreign object debris.

4. The optical control system of claim 3, wherein the control routine comprises at least one of a pump prioritization operation, a foreign object debris de-ragging operation, a well maintenance operation, or a pump parameter adjustment operation.

5. The optical control system of claim 1, wherein the memory stores processor-executable instructions that, when executed, further configure the control processor for generating an alert to a user based on the detected condition of the wet well.

6. The optical control system of claim 1, further comprising a mount for mounting the camera in the wet well.

7. The optical control system of claim 1, wherein the wet well comprises a window, and wherein the camera is mounted proximate the window on an exterior of the wet well.

8. The optical control system of claim 1, wherein the camera is configured to continuously monitor the wet well, and based on the detection of an event, capture the image of the wet well.

9. The optical control system of claim 8, further comprising a sensor associated with the wet well and wherein said event is triggered by receiving a cue from the sensor.

10. The optical control system of claim 9, wherein said event comprises detection by the sensor of a change in condition of the wet well.

11. The optical control system of claim 1, wherein the camera is configured to capture the image of the wet well at a scheduled interval.

12. The optical control system of claim 1, further comprising a reference marker disposed in the wet well and captured in the image, and wherein the memory stores processor-executable instructions that, when executed, further configure the control processor for using the reference marker to detect the condition of the wet well.

13. The optical control system of claim 1, wherein the control processor is integrated within the camera.

14. The optical control system of claim 1, wherein the control processor is remotely connected to the camera.

15. An optical control system for a wet well, the optical control system comprising:
a first camera configured to capture a first image of an interior of the wet well from a first angle;
a second camera configured to capture a second image of the interior of the wet well from a second angle different from the first angle;
a control processor coupled to the first and second cameras and configured to receive the first and second images; and
a memory storing processor-executable instructions that, when executed, configure the control processor for evaluating the first and second images to detect a position of an object in the wet well.

16. The optical control system of claim 15, wherein the processor-executable instructions configure the control processor for evaluating the first and second images to assess a depth to a top surface of water in the wet well.

17. The optical control system of claim 15, wherein the processor-executable instructions configure the control processor for evaluating the first and second images to quantify a size of the detected object.

18. A method of controlling a wet well, the method comprising:
monitoring, with a camera and a control processor coupled to the camera, a condition of the wet well;
detecting, by the control processor, a change in the condition of the wet well;
capturing, with the camera, an image of the wet well;
receiving, at the control processor, the image of the wet well; and
processing, with the control processor, the image of the wet well to determine a control routine for the wet well.

19. The method of claim 18, further comprising executing the control routine.

20. The method of claim 18, wherein said monitoring is executed at least one of continuously, at scheduled intervals, or when prompted by an event triggered by auxiliary equipment associated with the wet well.
